(19) United States
(12) Patent Application Publication
(10) Pub. No.: US 2006/0007127 A1
(43) Pub. Date: Jan. 12, 2006

(54) Keyboard/handwriting pad dually built computer system

(76) Inventor: Chih-Liang Huang, Taichung City (TW)

Correspondence Address: BACON & THOMAS, PLLC, 625 SLATERS LANE, FOURTH FLOOR, ALEXANDRIA, VA, 22314, US

(21) Appl. No.: 10/950,437

(22) Filed: Sep. 28, 2004

(30) Foreign Application Priority Data
Jun. 16, 2004 (TW) 93117370

(51) Int. Cl. G09G 5/00

(52) U.S. Cl. 345/156

(57) ABSTRACT

A keyboard/handwriting pad dually built computer system is comprised of a base member, a display device mounted on the base member, and a keyboard/handwriting dual input device reversibly mounted on the base member via a coupler and having a plate-like member, a handwriting pad mounted on a side of the plate-like member, and a keyboard having numerous keys and mounted on the other side of the plate-like member. Accordingly, the user can turn over the keyboard/handwriting dual input device to select the keyboard or the handwriting pad for input operation according to the user's demand.

### BACKGROUND OF THE INVENTION

1. Field of the Invention

The present invention relates generally to input apparatuses, and more particularly to a keyboard/handwriting pad dually built computer system.

2. Description of the Related Art

A conventional computer system is comprised of an input device for inputting commands or messages. The most well-known input device is the keyboard, which includes a great number of keys for input to enable selection, control, etc. The handwriting pad is an alternative input device for the user who is not familiar with the keyboard, enabling the user to write words thereon and then the words are processed by a handwriting recognition system to be inputted into the computer system. In addition, there are numerous other input devices, like mouse and microphone (voice input).

Although there are numerous input devices for options, some of the computer systems, like notebook computers, usually have to be light, thin, short, and small to have limited size, such that only a keyboard and a touch pad other than other input devices, which must be externally connected to the computer system if they are required, are built inside the computer system.

Nowadays, there is still none of an input device of the keyboard combined with the handwriting pad. If the handwriting pad is mounted on the backside of the keyboard, the handwriting input will be additional for the user's option without or at the expense of increasing little size.

### SUMMARY OF THE INVENTION

The primary objective of the present invention is to provide a keyboard/handwriting pad dually built computer system, which keyboard and handwriting pad are mounted at two sides thereof to have one morel input device than the prior art for the user's operation.

The secondary objective of the present invention is to provide a keyboard/handwriting pad dually built computer system, which handwriting pad is mounted on the backside of the keyboard at the expense of increasing little thickness but without interference of space where the keyboard and the handwriting pad are mounted.

The foregoing objectives of the present invention are attained by the keyboard/handwriting pad dually built computer system, which is comprised of a base member, a display device mounted on the base member, and a keyboard/handwriting dual input device reversibly mounted on the base member via a coupler and having a plate-like member, a handwriting pad mounted on a side of the plate-like member, and a keyboard having numerous keys and mounted on the other side of the plate-like member. Accordingly, the user can turn over the keyboard/handwriting dual input device to select the keyboard or the handwriting pad for input operation according to the user's demand.

### BRIEF DESCRIPTION OF THE DRAWINGS

FIG. 1 is a perspective view of a first preferred embodiment of the present invention;

FIG. 2 is an exploded view of the first preferred embodiment of the present invention;

FIG. 3 is a schematic view of the first preferred embodiment of the present invention, showing that the keyboard/handwriting dual input device is being turned over;

FIG. 4 is another perspective view of the first preferred embodiment of the present invention;

FIG. 5 is an exploded view of a second preferred embodiment of the present invention; and

FIG. 6 is a partially enlarged view of FIG. 5.

### DETAILED DESCRIPTION OF PREFERRED EMBODIMENTS

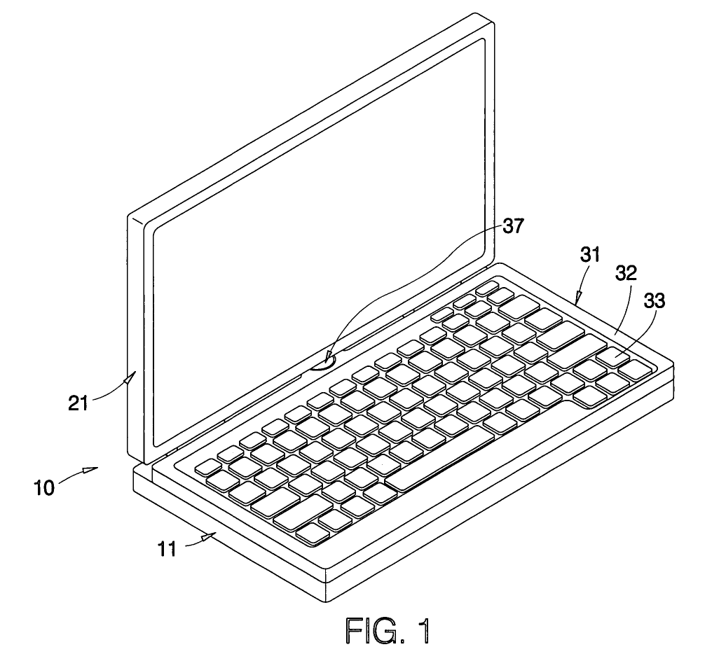

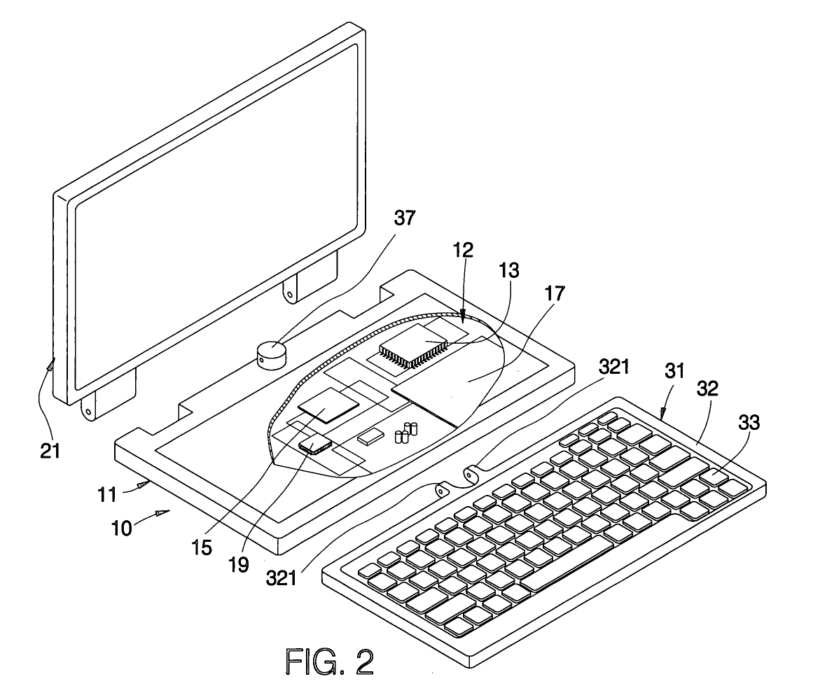

Referring to FIGS. 1-3, a keyboard/handwriting pad dually built computer system 10 constructed according to a first preferred embodiment of the preferred embodiment of the present invention is comprised of a base member 11, a display device 21, and a keyboard/handwriting dual input device 31.

The base member 11 includes inside a circuitry 12 required for executing at least one operating system. The circuitry 12 is comprised of a central processing unit (CPU) 13, a random access memory (RAM) module 15, a storage device 17, and a control chip 19. Because the circuitry 12 is well-known prior art, no further recitation is necessary.

The display device 21 is mounted on the base member 11 and is electrically connected to the circuitry 12. Because the display device 21 is well-known prior art, no further recitation is necessary.

The keyboard/handwriting dual input device 31 is reversibly mounted on the base member 11 via a coupler 37 and is electrically connected to the circuitry 12 of the base member 11. The keyboard/handwriting dual input device 31 includes a plate-like member 32, a keyboard 33 mounted on a side of the plate-like member 32 and having a plurality of keys, and a handwriting pad 35 mounted on the other side of the plate-like member 32. The coupler 37 is embodied as a pivotal shaft mounted on the base member 11. The plate-like member 32 has two lugs 321 formed at a front end thereof and pivotally mounted to two sides of the coupler 37. The coupler 37 can pivot for a predetermined angle, which is 180° in this embodiment. The two lugs 321 are pivotable with respect to the coupler 37. Thus, the user can turn over the keyboard/handwriting dual input device 31 and select either the keyboard 33 or the handwriting pad 35 for the input operation according to the user's demand.

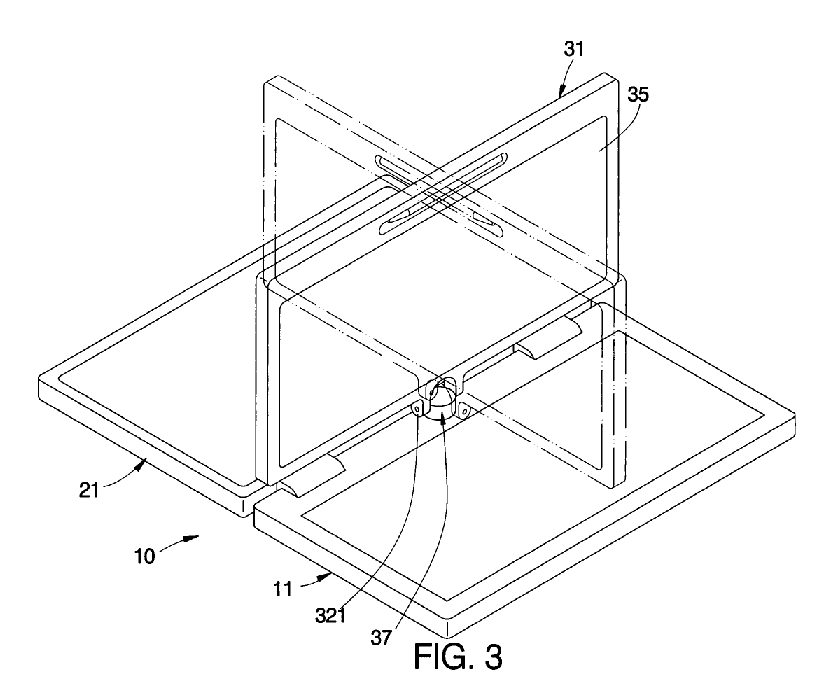

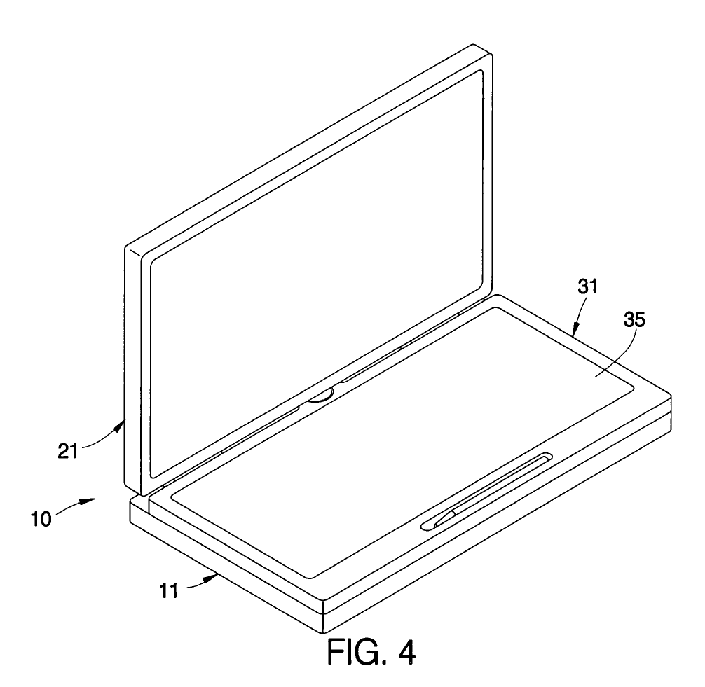

When the computer system 10 is operated, as shown in FIG. 1, the keyboard 33 faces upwards and the handwriting pad 35 faces downwards; meanwhile, the user can use the keyboard 33 for the input operation. When the user intends to use the handwriting pad 35, the user can turn the keyboard/handwriting dual input device 31 upwards from the base member 11 on the two lugs 321 as a pivot and then turn the keyboard/handwriting dual input device 31 rightwards or leftwards on the coupler 37 as a pivot for 180°, as shown in FIG. 3, and finally turn the keyboard/handwriting dual input device 31 downwards back into the base member 11, as shown in FIG. 4. In the meantime, the user can use the handwriting pad 35 for the handwriting input. When the user intends to use the keyboard 33 again, the user can turn over the keyboard/handwriting dual input device 31 to resume the original position as shown in FIG. 1.

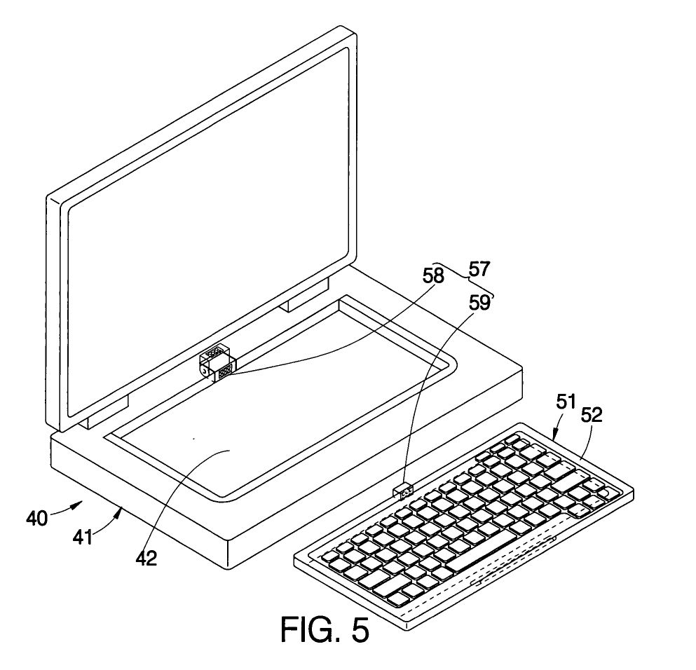

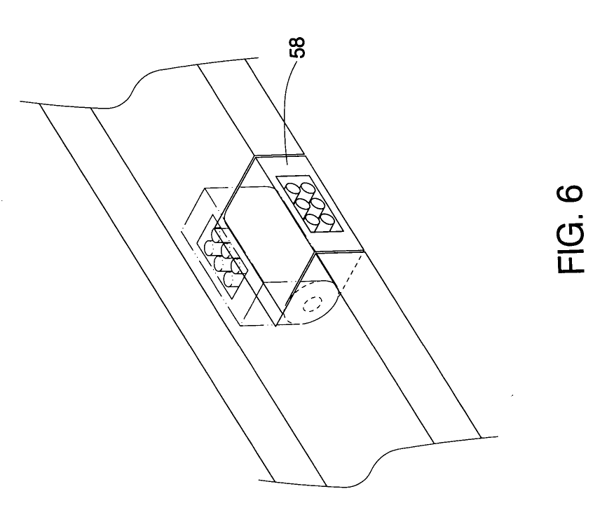

Referring to FIGS. 5 and 6, the keyboard/handwriting pad dually built computer system 40 constructed according to a second preferred embodiment of the preferred embodiment of the present invention is similar to the first preferred embodiment, having difference as follows.

The base member 41 is provided with a recessed portion 42 formed on a surface thereof. The keyboard/handwriting dual input device 51 is received in the recessed portion 42.

The coupler 57 includes a socket 58 and a plug 59. The socket 58 is mounted on the base member 41. The plug 59 is mounted on the plate-like member 52. The keyboard/handwriting dual input device 51 is plugged into the socket 58 via the plug 59.

When the computer system 40 is operated and the user intends to switch the keyboard/handwriting dual input device 51, the user can unplug the plug 69 from the socket 58 before turning over the keyboard/handwriting dual input device 51, and then plug the plug 59 into the socket 58 after turning over the keyboard/handwriting devce dual input device 51; meanwhile, the keyboard/handwriting dual input device 51 is received in the recessed portion 42.

It is to be noted that the coupler and the circuitry in the present invention can be other alternatives. In addition to the base member, the circuitry can be alternatively mounted in the keyboard/handwriting dual input device to attain the desirable result of the present invention.

In conclusion, the present invention includes advantages as follows.

1. More input options: The keyboard/handwriting dual input device is provided with the keyboard and the handwriting pad at both sides thereof, such that the user can turn over the keyboard/handwriting dual input device to have at least two options of the keyboard and the handwriting pad for the input operation, superior to the prior art to have one more option of input.

2. No increased transversal size: Because the handwriting pad is mounted beside the backside of the keyboard, the whole computer system will not have increased perimeter or area but slightly increased thickness. As for the notebook computers or electronic books, the present invention is an outstanding design for them not to have transversally increased size but to have an additional handwriting input media for the user's extra option of input.

What is claimed is:

1. A keyboard/handwriting pad dually built computer system comprising:
a base member;
a display device mounted on said base member; and
a keyboard/handwriting dual input device reversibly mounted on said base member via a coupler and having a plate-like member, a handwriting pad mounted on a side of said plate-like member, and a keyboard having a plurality of keys and mounted on the other side of said plate-like member;
whereby the user can turn over the keyboard/handwriting dual input device to select said keyboard or said handwriting pad for input operation according to the user's demand.

2. The computer system as defined in claim 1 further comprising a circuitry, said circuitry having a CPU, a RAM module, a storage device, and a control chip, said circuitry being electrically connected with said keyboard/handwriting dual input device.

3. The computer system as defined in claim 2, wherein said circuitry is disposed in said base member.

4. The computer system as defined in claim 1, wherein said base member comprises a recessed portion on a surface thereof; said keyboard/handwriting dual input device is received in said recessed portion of said base member.

5. The computer system as defined in claim 1, wherein said coupler is a pivotal shaft mounted on said base member; said plate-like member comprises two lugs formed at a front end thereof and pivotally mounted respectively at two sides of said pivotal shaft, said pivotal shaft of said coupler being pivotable relatively to said base member for a predetermined angle, said two lugs of said plate-like member being pivotable relatively to sad pivotal shaft.

6. The computer system as defined in claim 1, wherein said coupler comprises a socket and a plug, said socket being mounted on said base member, said plug is mounted on said plate-like member, said keyboard/handwriting dual input device being plugged into said socket via said plug.
